(19) United States
(12) Patent Application Publication
(10) Pub. No.: US 2019/0270226 A1
(43) Pub. Date: Sep. 5, 2019

(54) PROCESS FOR PRODUCING MOTOR VEHICLE SEAT CUSHIONING

(71) Applicant: TESCA France, Paris (FR)

(72) Inventor: Laurent Georges, Roizy (FR)

(21) Appl. No.: 16/319,889

(22) PCT Filed: Jul. 25, 2017
(86) PCT No.: PCT/FR2017/052076

§ 371 Date: Jan. 23, 2019

(30) Foreign Application Priority Data
Jul. 26, 2016 (FR) 1657175

(51) Int. Cl. B29C 44/12; B29C 44/14

(52) U.S. Cl. CPC B29C 44/1261; B29K 2075/00; B29C 44/145; B29C 44/1285

(57) ABSTRACT

The invention relates to a process for producing a motor vehicle seat cushion comprising the following steps: providing a cover with an insert, the insert having a layer of coating material and a foam sublayer; placing the cover in a mold; positioning a thermoplastic film on the sublayer; injecting a foam precursor mixture to produce a block of padding. The film used is based on polyurethane with a melting point between 40° C. and 60° C. and a melt-mass flow rate greater than 15 g/10 min. The film degrades under the action of the heat released during the formation of the foam of the block to enable an overmolding of the sublayer by the block substantially without penetration of the foam of the block into the thickness of the sublayer.

### CROSS-REFERENCE TO RELATED APPLICATION

This application claims the benefit of International application number PCT/FR2017/052076, filed Jul. 25, 2017 and French application number 1657175, filed Jul. 26, 2016 the entire contents of which are incorporated herein by reference.

### TECHNICAL FIELD

The invention relates to a process for producing motor vehicle seat cushioning, cushioning produced by such a process and a motor vehicle seat provided with such cushioning.

### BACKGROUND

It is known, in particular from the document EP-0 463 981, to implement a process for producing motor vehicle seat cushioning, the process comprising the following steps:
providing a cover comprising a first insert, the insert comprising a layer of coating material and a sublayer of elastically compressible foam in particular containing polyurethane,
placing the cover in a mold defining a molding cavity, the front face of the cover being disposed against the wall of the cavity,
positioning a thermoplastic film on the sublayer,
injecting, into the cavity, a mixture that is a precursor of elastically compressible foam, so as to produce a block of padding,
after expansion of the foam, removing the cushioning obtained from the mold,

the film having physico-chemical properties arranged so that it progressively degrades under the action of the heat released during the formation of the foam of the block, in order to enable an overmolding of the sublayer by the block while limiting the penetration of the foam of the block into the thickness of the sublayer.

With such a process, cushioning is produced, the cover of which is rigidly connected, via the first insert, to the block of padding, which prevents having to use return means as conventionally used in the case of covers mounted by fitting over a block.

Moreover, the presence of the film allows to limit the formation of impermeable crust because of a penetration of the foam of the block into a fraction of thickness of the sublayer, which allows to have cushioning having a certain hygrothermal comfort related to the porosity of the residual crust.

However, the applicant has observed that the films proposed in the prior art only allow to solve the problem of hygrothermal comfort imperfectly, the residual crust not having sufficient porosity to provide optimal comfort of the cushioning.

### SUMMARY OF THE INVENTION

The object of the invention is to propose a process allowing to solve this technical problem, in order to obtain cushioning having optimal hygrothermal comfort.

For this purpose, and according to a first aspect, the invention proposes a process for producing motor vehicle seat cushioning, the process comprising the following steps:
providing a cover comprising a first insert, the insert comprising a layer of coating material and a sublayer of elastically compressible foam,
placing the cover in a mold defining a molding cavity, the front face of the cover being disposed against the wall of the cavity,
positioning a thermoplastic film on the sublayer,
injecting, into the cavity, a mixture that is a precursor of elastically compressible foam, so as to produce a block of padding,
after expansion of the foam, removing the cushioning obtained from the mold,

the process further having the following features:
the film is based on polyurethane,
the melting point thereof is between 40 and 60° C.,
the melt-mass flow rate thereof, measured according to the standard NF T 51-016, at 190° C. with a forced-flow capillary rheometer, the piston of which is loaded with a mass of 2.160 kg, is greater than 15 g/10 min,

so that the film degrades under the action of the heat released during the formation of the foam of the block, in order to enable an overmolding of the sublayer by the block substantially without penetration of the foam of the block into the thickness of the sublayer.

The development of such a process results from a fine selection that followed a very large number of tests carried out by the applicant.

The latter observed that the essential parameters were on the one hand the melting temperature and on the other hand the fluidity of the film in the melted state.

With regard to the parameter of fluidity, the applicant has in particular observed that a film having insufficient fluidity in the melted state could not degrade in such a way as to lose its impermeability.

As a result, the cushioning cannot, under these conditions, be provided with the expected characteristics of hygrothermal comfort.

By using a film as recommended, it is possible to perfectly control the non-penetration of the foam of the block into the foam sublayer, the film degrading once the foam being formed has taken on a consistency preventing it from penetrating into the sublayer.

Moreover, the applicant has observed that the use of such a film allows to produce a very robust association between the first insert and the block, and this despite the non-penetration of the foam of the block into the thickness of the foam sublayer.

According to other aspects, the invention proposes cushioning produced by such a process and a motor vehicle seat comprising such cushioning.

### BRIEF DESCRIPTION OF THE DRAWING

Other particularities and advantages of the invention will appear in the following description, given in reference to the appended drawings, in which:

FIG. 1 is a diagram of a partial cross-section of cushioning being manufactured, the foam precursor mixture having just been injected into the cover,

FIG. 2 is a diagram of a partial cross-section, according to one embodiment, of the cushioning of FIG. 1 once produced.

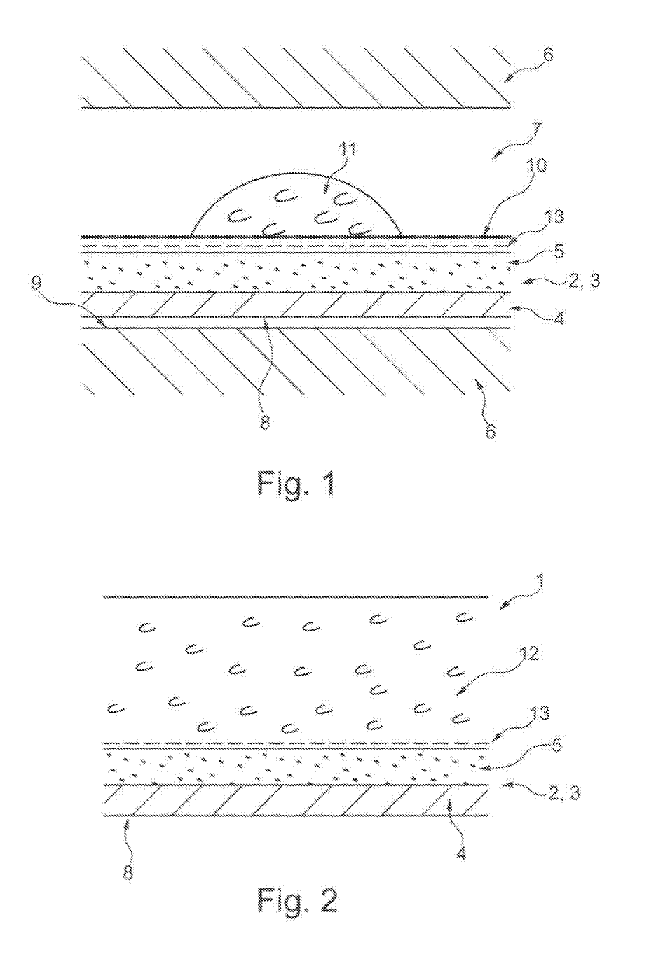

### DETAILED DESCRIPTION

In reference to the drawings, a process for producing motor vehicle seat cushioning 1 is described, the process comprising the following steps:
providing a cover 2 comprising a first insert 3, the insert comprising a layer of coating material 4 and a sublayer 5 of elastically compressible foam,
placing the cover in a mold 6 defining a molding cavity 7, the front face 8 of the cover being disposed against the wall 9 of the cavity,
positioning a thermoplastic film 10 on the sublayer,
injecting, into the cavity—directly onto the film in the embodiment shown—a mixture 11 that is a precursor of elastically compressible foam, so as to produce a block 12 of padding,
after expansion of the foam, removing the cushioning 1 obtained from the mold,

the process further having the following features:
the film is based on polyurethane,
the melting point thereof is between 40 and 60° C.,
the melt-mass flow rate thereof, measured according to the standard NF T 51-016 at 190° C. with a forced-flow capillary rheometer, the piston of which is loaded with a mass of 2.160 kg, is greater than 15 g/10 min,

so that the film degrades under the action of the heat released during the formation of the foam of the block, in order to enable an overmolding of the sublayer by the block substantially without penetration of the foam of the block into the thickness of the sublayer.

Heating of the mold 6 can optionally be provided, for example to a temperature of approximately 45 to 55° C., in order to aid the degradation of the film 10.

According to one embodiment, the melt-mass flow rate of the film 10, measured according to the standard NF T 51-016 at 190° C. with a forced-flow capillary rheometer, the piston of which is loaded with a mass of 2.160 kg, is less than 50 g/10 min.

According to one embodiment, the melt-mass flow rate of the film 10, measured according to the standard NF T 51-016 at 190° C. with a forced-flow capillary rheometer, the piston of which is loaded with a mass of 2.160 kg, is equal to 25±3 g/10 min.

According to one embodiment, the film 10 has a thickness of 15±3 microns, and in particular a thickness of 15±1 microns.

According to one embodiment, the density of the film 10 is 1.20±0.05.

According to one embodiment, the film 10 has, under differential scanning calorimetry (DSC) analysis, carried out according to the standard ISO 11357, a melting peak located at 49±2° C.

According to one embodiment, the polyol used to produce the film 10 contains polyester.

According to one embodiment, the isocyanate used to produce the film 10 comprises an aromatic group.

According to one embodiment, the foam sublayer 5 contains polyurethane.

According to one embodiment, the foam sublayer 5 has a density of 0.028±0.002, which usually corresponds to a mediocre quality of foam used for covers 2 associated with a block 12 of padding via fitting and not via overmolding of the cover by the block.

The use of such a sublayer 5, having a low cost, allows to produce cushioning 1 having a minimised cost.

According to one embodiment, the foam sublayer 5 has a thickness between 1.5 and 2 mm.

According to the embodiment shown, the foam sublayer 5 is provided, on its outer face, with a protective fabric 13, in particular made of rectilinear or circular mesh.

According to one embodiment, the cover 2 comprises a second insert, not shown, associated edge to edge, in particular via sewing, with the first insert 3, the second insert being not overmolded by the block 12 of padding.

According to one embodiment, the second insert is located in the lateral portion of the cushioning 1, its dissociation from the block 12 of padding allowing better resistance of the block with regard to the bending that it undergoes during the entry/exit of the passengers into/out of the vehicle.

According to one embodiment, the foam of the block 12 has a different density according to whether it is located facing the first 3 or second insert, the foam having in particular an increased density in lateral portions of the cushioning 1, so as to allow firm lateral retention of the passenger.

Finally, motor vehicle seat cushioning 1 produced by such a process is described, the cushioning comprising:
a cover 2 comprising a first insert 3, the insert comprising a layer of coating material 4 and a sublayer 5 of elastically compressible foam in particular containing polyurethane,
a block 12 of padding made of elastically compressible foam, the block overmolding the insert while leaving the sublayer substantially devoid of foam in its thickness.

Finally, in a manner not shown, a motor vehicle seat comprising such cushioning 1 is described, the cushioning being associated, by the periphery of the cover 2, with a frame of the seat.

In order to carry out this association, profiles are in particular used, fastened, for example via sewing, at the periphery of the cover 2, the profiles being inserted into anchoring portions provided on the frame of the seat.

What is claimed is:

1. A process for producing motor vehicle seat cushioning, the process comprising the following steps:
providing a cover comprising a first insert, the insert comprising a layer of coating material and a sublayer of elastically compressible foam,
placing the cover in a mold defining a molding cavity, the front face of the cover being disposed against the wall of the cavity,
positioning a thermoplastic film on the sublayer,
injecting, into the cavity, a mixture that is a precursor of elastically compressible foam, to produce a block of padding,
after expansion of the foam, removing the cushioning obtained from the mold,
the process wherein:
the film is based on polyurethane,
the melting point of the film is between 40 and 60° C.,
the melt-mass flow rate of the film, measured according to the standard NF T 51-016 at 190° C. with a forced-flow capillary rheometer, the piston of which is loaded with a mass of 2.160 kg, is greater than 15 g/10 min,
so that the film degrades under the action of the heat released during the formation of the foam of the block, enabling an overmolding of the sublayer by the block substantially without penetration of the foam of the block into the thickness of the sublayer.

2. The process according to claim 1, wherein the melt-mass flow rate of the film, measured according to the standard NF T 51-016 at 190° C. with a forced-flow capillary rheometer, the piston of which is loaded with a mass of 2.160 kg, is less than 50 g/10 min.

3. The process according to claim 1, wherein the melt-mass flow rate of the film, measured according to the standard NF T 51-016 at 190° C. with a forced-flow capillary rheometer, the piston of which is loaded with a mass of 2.160 kg, is equal to 25±3 g/10 min.

4. The process according to claim 1, wherein the film has a thickness of 15±3 microns, and in particular a thickness of 15±1 microns.

5. The process according to claim 1, wherein the film has, under differential scanning calorimetry (DSC) analysis, carried out according to the standard ISO 11357, a melting peak located at 49±2° C.

6. The process according to claim 1, wherein polyol is used to produce the film and contains polyester.

7. The process according to claim 1, wherein isocyanate is used to produce the film and comprises an aromatic group.

8. The process according to claim 1, wherein the foam sublayer has a density of 0.028±0.002.

9. A motor vehicle seat cushioning produced by a process according to claim 1, the cushioning comprising:
a cover comprising a first insert, the insert comprising a layer of coating material and a sublayer of elastically compressible foam in particular containing polyurethane,
a block of padding made of elastically compressible foam, the block overmolding the insert while leaving the sublayer substantially devoid of foam in its thickness.

10. The motor vehicle seat comprising cushioning according to claim 9, the cushioning being associated, by the periphery of the cover, with a frame of the seat.
